(19) United States
(12) Patent Application Publication
(10) Pub. No.: US 2023/0415649 A1
(43) Pub. Date: Dec. 28, 2023

(54) VEHICLE VIEWING DEVICE

(71) Applicant: KABUSHIKI KAISHA TOKAI-RIKA-DENKI-SEISAKUSHO, Niwa-gun (JP)

(72) Inventors: Takehiro HAMADA, Aichi (JP); Yuto NAKAYAMA, Aichi (JP)

(21) Appl. No.: 18/338,626

(22) Filed: Jun. 21, 2023

(30) Foreign Application Priority Data
Jun. 23, 2022 (JP) 2022-101361

(51) Int. Cl. B60R 1/072

(52) U.S. Cl. CPC B60R 1/072

(57) ABSTRACT

A vehicle viewing device 10 includes a mirror 20 that is configured to assist viewing by an occupant, a mirror-face adjustment device 30 that is configured to adjust a mirror-face 20A of the mirror 20, and a support member 40 that is formed with attachment holes 43, wherein the attachment holes 43 enable attachment of the mirror-face adjustment device 30, with translation, to the support member 40. The mirror-face adjustment device 30 is attached to the support member 40 with the attachment position of the mirror-face adjustment device 30 with respect to the support member 40 changed. This enables the position of the mirror-face adjustment device 30 to be changed to match a shape of the mirror 20.

### CROSS-REFERENCE TO RELATED APPLICATION

This application claims priority under 35 USC 119 from Japanese Patent Application No. 2022-101361 filed on Jun. 23, 2022, the disclosure of which is incorporated by reference herein in its entirety.

### BACKGROUND

### Technical Field

The present disclosure relates to a vehicle viewing device.

### Related Art

A vehicle viewing device that includes a mirror-face adjustment device to adjust a face of a mirror is known (see, for example, Japanese Patent Application Laid-Open (JP-A) No. H8-276789).

JP-A No. H8-276789 discloses technology for a tiltable door mirror including a support frame to support a mirror body of a door mirror provided to a vehicle, and a mirror-face adjustment actuator unit fixed to the support frame, wherein the support frame is provided with a single datum screw hole, and plural tilt-adapted screw holes at locations separated from the datum screw hole. This thereby enables the support frame and mirror-face adjustment actuator unit to be employed commonly to both situations when attachment is made with a specific tilt imparted to a rotation axis of the mirror body and situations when attachment is made without imparting such tilt.

Preferably a support member is made common across mirrors of different shapes in a vehicle viewing device including a mirror-face adjustment device.

### SUMMARY

An object of the present disclosure is to make a support member common across mirrors of different shapes.

A vehicle viewing device of a first aspect of the present disclosure includes a mirror that is configured to assist viewing by an occupant, a mirror-face adjustment device that is configured to adjust a mirror-face of the mirror, and a support member that is formed with attachment holes, wherein the attachment holes enable attachment of the mirror-face adjustment device, with translation, to the support member.

A vehicle viewing device of a second aspect of the present disclosure is the vehicle viewing device of the first aspect of the present disclosure, wherein a direction of translation includes at least one of a first direction or a second direction that is different from the first direction.

A vehicle viewing device of a third aspect of the present disclosure is the vehicle viewing device of the first aspect or the second aspect of the present disclosure, wherein the attachment holes are provided so as to enable attachment of the mirror-face adjustment device, with rotational movement, to the support member.

A vehicle viewing device of a fourth aspect of the present disclosure is the vehicle viewing device of any one of the first aspect to the third aspect of the present disclosure, wherein the attachment hole includes a first attachment hole provided at a first face, and a second attachment hole provided at a second face that is inclined with respect to the first face.

A vehicle viewing device of a fifth aspect of the present disclosure is the vehicle viewing device of any one of the first aspect to the fourth aspect of the present disclosure, wherein the support member is integrally formed to a stowing device that stows a visor housing the mirror-face adjustment device.

A vehicle viewing device of a sixth aspect of the present disclosure is the vehicle viewing device of any one of the first aspect to the fifth aspect of the present disclosure, wherein the support member includes a plurality of fastening zones configured to fasten the mirror-face adjustment device to the support member, and the attachment holes formed in the respective fastening zones are formed with rotational symmetry with respect to an attachment center of the support member, and there is at least one fastening zone in which an attachment hole is not formed, at a position corresponding to any one of the attachment holes formed in one of the plurality of fastening zones.

A vehicle viewing device of a seventh aspect of the present disclosure is the vehicle viewing device of any one of the first aspect to the sixth aspect of the present disclosure, wherein a positioning pin formed at the mirror-face adjustment device is inserted into at least one of the attachment holes.

A vehicle viewing device of an eighth aspect of the present disclosure is the vehicle viewing device of any one of the first aspect to the seventh aspect of the present disclosure, wherein an attachment member, configured to attach a reinforcement member to reinforce the support member, is inserted into at least one of the attachment holes.

A vehicle viewing device of a ninth aspect of the present disclosure is the vehicle viewing device of any one of the first aspect to the eighth aspect of the present disclosure, wherein a plurality of through holes configured to attach a visor are provided at the support member.

The vehicle viewing device of the first aspect of the present disclosure includes the support member that is formed with attachment holes, wherein the attachment holes enable attachment of the mirror-face adjustment device, with translation, to the support member, and so the mirror-face adjustment device is attached to the support member with the attachment position of the mirror-face adjustment device changed with respect to the support member. This accordingly enables the position of the mirror-face adjustment device to be changed to match a shape of a mirror. As a result thereof, a support member can be made common across mirrors of different shapes.

In the vehicle viewing device of the second aspect of the present disclosure, the direction of translation includes at least one of the first direction or the second direction that is different from the first direction such that the mirror-face adjustment device is attached with translation in the at least one of the first direction or the second direction. The mirror-face adjustment device is accordingly disposed at a more targeted position with respect to mirrors of different shapes.

In the vehicle viewing device of the third aspect of the present disclosure, the attachment holes are provided so as to enable attachment of the mirror-face adjustment device, with rotational movement, to the support member, thereby enabling the mirror-face adjustment device to be attached to the support member both translated with respect to the support member and furthermore rotationally moved. The mirror-face adjustment device is accordingly disposed at a more targeted position with respect to mirrors of different shapes.

In the vehicle viewing device of the fourth aspect of the present disclosure, the attachment holes include the first attachment hole provided at the first face, and the second attachment hole provided at the second face that is inclined with respect to the first face, such that the orientation of the mirror-face adjustment device is changed between when the mirror-face adjustment device is attached at the first attachment hole and when the mirror-face adjustment device is attached at the second attachment hole. This thereby enables the mirror-face adjustment device to be translated with respect to the support member, and furthermore for the orientation of the mirror-face adjustment device to be changed.

In the vehicle viewing device of the fifth aspect of the present disclosure, the support member is integrally formed to a stowing device that stows a visor housing the mirror-face adjustment device, and so the number of components can be reduced.

In the vehicle viewing device of the sixth aspect of the present disclosure, the attachment holes formed in the respective fastening zones are formed with rotational symmetry with respect to the attachment center of the support member, and so the mirror-face adjustment device is attached, with rotational movement and translation, to the support member. Moreover, the attachment holes formed in the respective fastening zones are formed at least at one different position therein (that is, there is at least one fastening zone in which an attachment hole is not formed, at a position corresponding to any one of the attachment holes formed in one of a plurality of fastening zones.), thereby enabling incorrect assembly to be suppressed from occurring. This means that the mirror-face adjustment device can be disposed at a more targeted position to match mirrors of different shapes while also suppressing incorrect assembly.

In the vehicle viewing device of the seventh aspect of the present disclosure, a positioning pin formed at the mirror-face adjustment device is inserted into the at least one of the attachment holes such that positioning of the mirror-face adjustment device with respect to the support member can be performed by employing an attachment hole not needed for attachment of the mirror-face adjustment device.

In the vehicle viewing device of the eighth aspect of the present disclosure, the attachment member, configured to attach a reinforcement member to reinforce the support member, is inserted into at least one of the attachment holes, such that the reinforcement member is attached by employing the attachment hole not needed for attachment of the mirror-face adjustment device. This thereby enables the support member to be reinforced by employing the attachment hole not needed for attachment of the mirror-face adjustment device.

In the vehicle viewing device of the ninth aspect of the present disclosure, the plural of through holes configured to attach a visor are provided at the support member, thereby enabling the attachment position of the visor to be changed. Thus when the position of the mirror-face adjustment device is changed to match the shape of the mirror, this thereby enables the attachment position of the visor to also be changed in accordance therewith.

### BRIEF DESCRIPTION OF THE DRAWINGS

The above object and other objects, features, and advantages of the present disclosure will become apparent from the following detailed description with reference to the appended drawings. In the drawings:

FIG. 1 is a plan view illustrating a vehicle viewing device according to a first exemplary embodiment;

FIG. 2 is a face-on view illustrating a vehicle viewing device according to the first exemplary embodiment, as viewed from the vehicle front side toward the vehicle rear side;

FIG. 3 is a cross-sectional view illustrating a vehicle viewing device according to the first exemplary embodiment, and illustrates a cross-section cut along line A-A of FIG. 2;

FIG. 4 is a face-on view illustrating a mirror-face adjustment device and a mirror of a vehicle viewing device according to the first exemplary embodiment, as viewed from the vehicle front side toward the vehicle rear side;

FIG. 5 is a face-on view illustrating states in which mirrors of different sizes are attached to a support member according to the first exemplary embodiment, as viewed from the vehicle front side toward the vehicle rear side;

FIG. 6 is an exploded face-on view illustrating a vehicle viewing device according to a second exemplary embodiment;

FIG. 7A illustrates an attachment state of a mirror-face adjustment device according to the second exemplary embodiment to a support member, illustrated in an attached state to a small mirror;

FIG. 7B illustrates an attachment state of a mirror-face adjustment device according to the second exemplary embodiment to a support member, illustrated in an attached state to a medium sized mirror;

FIG. 7C illustrates an attachment state of a mirror-face adjustment device according to the second exemplary embodiment to a support member, illustrated in an attached state to a large mirror;

FIG. 8 is a face-on view of a vehicle viewing device according to a third exemplary embodiment, as viewed from the vehicle front side toward the vehicle rear side;

FIG. 9 is a face-on view of a vehicle viewing device according to a fourth exemplary embodiment, as viewed from the vehicle front side toward the vehicle rear side; and

FIG. 10 is a cross-sectional view of a vehicle viewing device according to a fifth exemplary embodiment.

### DETAILED DESCRIPTION OF THE INVENTION

### First Exemplary Embodiment

Description follows regarding a vehicle viewing device 10 according to a first exemplary embodiment, with reference to the drawings. In the first exemplary embodiment, an example will be described in which the vehicle viewing device 10 is a door mirror for attaching to a front side door of a vehicle.

Note that in the drawings an arrow UP indicates a vehicle upper side, an arrow FR indicates a vehicle front side, an arrow RR indicates a vehicle rear side, and an arrow OUT indicates a vehicle width direction outside. Moreover, the vehicle rear side of a vehicle front-rear direction D is sometimes referred to as a front-face side and a vehicle front side thereof is sometimes referred to as a back-face side.

### Configuration of First Exemplary Embodiment

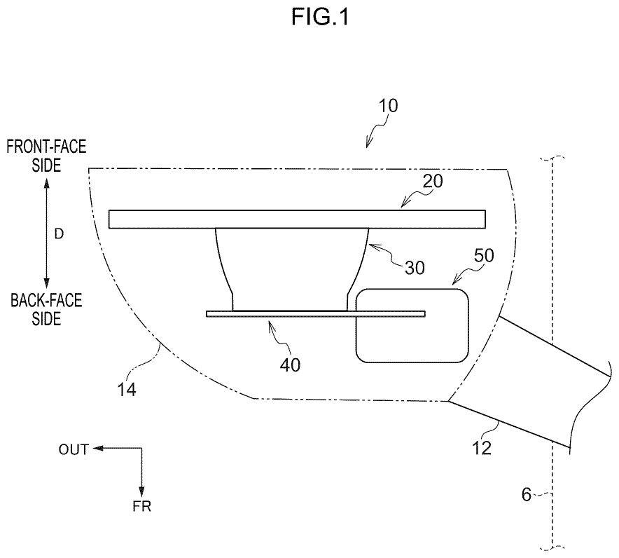

As illustrated in FIG. 1, the vehicle viewing device 10 according to the first exemplary embodiment is attached to an outside of a front side door of a vehicle 6, and is employed for a viewing rearward of the vehicle by an occupant (in particular a driver).

The vehicle viewing device 10 includes a visor 14, and a support section 12 to support the visor 14. The support section 12 is attached to a vehicle width direction outside of the front side door of the vehicle 6.

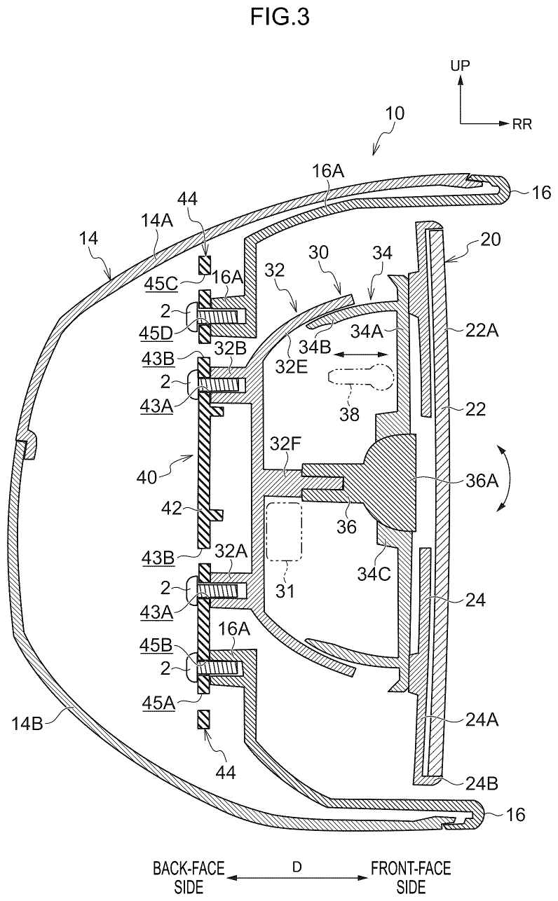

As illustrated in FIG. 3, the visor 14 is configured by an upper cover 14A on the upper side and a lower cover 14B on the lower side that are combined in a bag shape open toward the vehicle rear.

As illustrated in FIG. 1, the visor 14 internally houses a mirror 20, a mirror-face adjustment device 30, a support member 40, and a stowing device 50.

Mirror 20

As illustrated in FIG. 3, the mirror 20 includes a mirror section 22, and a mirror holder 24 to hold the mirror section 22.

The mirror section 22 is formed in a substantially rectangular shape in face-on viewed from the vehicle rear side toward the vehicle front side, with the visor 14 provided such that a mirror-face 22A that is a front-face is exposed facing toward the vehicle rear. Viewing rearward of the vehicle by the occupant is assisted thereby.

The mirror holder 24 is made of a resin and formed in a substantially rectangular plate shape including a base 24A and a frame 24B. A back-face of the mirror section 22 is supported by the base 24A, and a peripheral edge of the mirror section 22 is held by the frame 24B.

Mirror-Face Adjustment Device 30

The mirror-face adjustment device 30 is disposed at the vehicle front side of the mirror 20, and includes a case 32, a cover 34, a holder 36, rod drives 38, and a motor 31 serving as a drive means. The mirror-face adjustment device 30 is configured so as to adjust the angle of the mirror-face 22A of the mirror 20 electrically.

Case 32

The case 32 includes a support wall 32E shaped in a spherical wall, and a fitting insert pillar 32F for fitting into the holder 36.

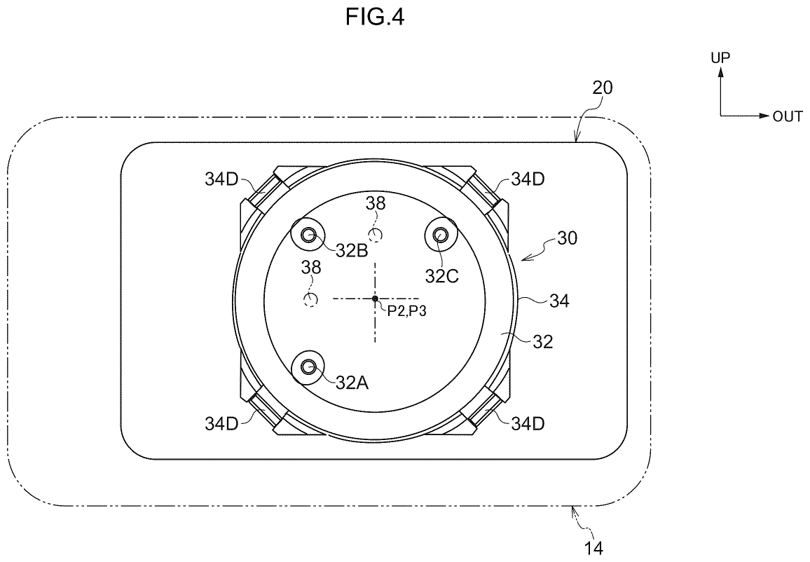

As illustrated in FIG. 3 and FIG. 4, a back-face of the case 32 is provided with a first boss 32A, a second boss 32B, and a third boss 32C that serve as attachment portions protruding in boss shapes at the back-face side. As illustrated in FIG. 4, the first boss 32A, the second boss 32B, and the third boss 32C are disposed so as to form an isosceles right-triangle as viewed from the vehicle rear side toward the vehicle front side.

The mirror-face adjustment device 30 is attached through the first boss 32A, the second boss 32B, and the third boss 32C to the support member 40 by screws 2 serving as attachment members. The mirror-face adjustment device 30 is able to be rotated with respect to a center position (center of gravity position) P3 and attached to the support member

Cover 34

As illustrated in FIG. 3, the cover 34 includes a base portion 34A for attachment of the mirror 20 disposed at the front-face side of the case 32, and a slide wall 34B with a spherical wall shape that upstanding from the base portion 34A toward the back-face side.

As illustrated in FIG. 3 and FIG. 4, fitting portions 34D for fitting together with claws provided to the mirror 20 are provided to the base portion 34A. The base portion 34A is attached to the mirror 20 such that the center position P3 of the mirror-face adjustment device is aligned with a center position (center of gravity position) P2 of the mirror 20.

An outer peripheral face of the slide wall 34B abuts an inner peripheral face of the support wall 32E, and the slide wall 34B is supported so as to be able to tilt and slide against the support wall 32E.

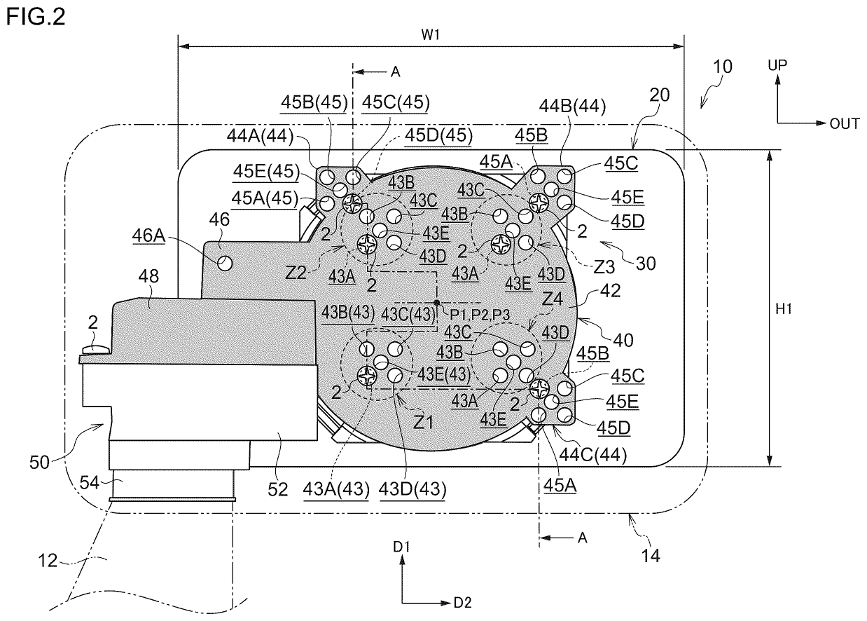

At the center position (center of gravity position) P2 (see FIG. 2) of the mirror 20, an attachment wall 34C shaped in substantially spherical tube serving as an attachment portion is formed to the base portion 34A.

Holder 36

A holding sphere 36A of the holder 36 is fitted into inside the attachment wall 34C, with the attachment wall 34C being held thereby so as to be able to tilt and slide against the holding sphere 36A.

Rod Drives 38

As illustrated in FIG. 4, the rod drives 38 are provided between the first boss 32A and the second boss 32B and between the second boss 32B and the third boss 32C, as viewed from the vehicle rear side toward the vehicle front side. A leading end on the vehicle rear side of each of the rod drives 38 is held so as to be slidable with respect to the base portion 34A of the cover 34.

Support Member 40

As illustrated in FIG. 2 and FIG. 3, the support member 40 is disposed at a vehicle front side of the mirror-face adjustment device 30. The support member 40 is made from a resin and includes a main body 42, attachment seats 44, an arm 46, and a cover 48.

Main Body 42

The main body 42 is formed in a circular plate shape. A first zone Z1, a second zone Z2, a third zone Z3, and a fourth zone Z4 are provided to the main body 42 as fastening zones to which the first boss 32A, the second boss 32B, and the third boss 32C of the mirror-face adjustment device 30 are fastened using the screws 2.

The fastening zones are formed at positions having rotational symmetry with respect to each other about a center position (center of gravity position) P1 of the main body 42. The first zone Z1 is a zone that is inside in the vehicle width direction and obliquely downwards with respect to the center position P1. The second zone Z2 is a zone that is inside in the vehicle width direction and obliquely upwards with respect to the center position P1. The third zone Z3 is a zone that is outside in the vehicle width direction and obliquely upwards with respect to the enter position P1. The fourth zone Z4 is a zone that is outside in the vehicle width direction and obliquely downwards with respect to the center position P1.

Attachment holes 43 are formed in each of the fastening zones so as to pierce through the main body 42 in the thickness direction thereof. The screws 2 are inserted into the attachment holes 43 so as to be attached to the first boss 32A, the second boss 32B, and the third boss 32C. The attachment holes 43 are configured by a first attachment hole 43A, a second attachment hole 43B, a third attachment hole 43C, a fourth attachment hole 43D, and a fifth attachment hole 43E.

The first attachment hole 43A, the second attachment hole 43B, the third attachment hole 43C, and the fourth attachment hole 43D are formed at apexes of a square. The fifth attachment hole 43E is formed at a center of the square. The second attachment hole 43B is formed at a vehicle upper side with respect to the first attachment hole 43A. The fourth attachment hole 43D is formed at a vehicle width direction outside with respect to the first attachment hole 43A. The fifth attachment hole 43E is formed at a vehicle upper side and vehicle width direction outside with respect to the first attachment hole 43A. The third attachment hole 43C is formed at a vehicle upper side and vehicle width direction outside with respect to the fifth attachment hole 43E.

The placement pitch between the first boss 32A and the second boss 32B and the placement pitch between the second boss 32B and the third boss 32C are formed so as to be the same as a placement pitch between the attachment holes 43 of the first zone Z1 and the attachment holes 43 of the second zone Z2, a placement pitch between the attachment holes 43 of the second zone Z2 and the attachment holes 43 of the third zone Z3, a placement pitch between the attachment holes 43 of the third zone Z3 and the attachment holes 43 of the fourth zone Z4, and a placement pitch between the attachment holes 43 of the fourth zone Z4 and an attachment hole 43 of the first zone Z1. For example, the placement pitch between the first attachment hole 43A of the first zone Z1 and the first attachment hole 43A of the second zone Z2 is formed so as to be the same as both the placement pitch between the first boss 32A and the second boss 32B and the placement pitch between the second boss 32B and the third boss 32C. For attachment to the support member 40, the mirror-face adjustment device 30 uses the first attachment holes 43A, the second attachment holes 43B, the third attachment holes 43C, the fourth attachment holes 43D, or the fifth attachment holes 43E of three of the fastening zones from out of four fastening zones.

The vehicle upper direction will be referred to as a first direction D1, and a outside direction in the vehicle width direction will be referred to as a second direction D2. The mirror-face adjustment device 30 is able to adopt a first attachment state attached at the first attachment holes 43A of the first zone Z1, the second zone Z2, and the third zone Z3, a second attachment state attached at the second attachment holes 43B thereof, a third attachment state attached to the third attachment holes 43C thereof, a fourth attachment state attached to the fourth attachment holes 43D thereof, and a fifth attachment state attached to the fifth attachment holes 43E thereof.

The second attachment state is a state in which the mirror-face adjustment device 30 is translated in the first direction D1 with respect to the first attachment state and attached to the support member 40. The fourth attachment state is a state in which the mirror-face adjustment device 30 is translated in the second direction D2 with respect to the first attachment state and attached to the support member 40. The fifth attachment state is a state in which the mirror-face adjustment device 30 is translated in both the first direction D1 and the second direction D2 with respect to the first attachment state and attached to the support member 40. The third attachment state is a state in which the mirror-face adjustment device 30 is translated in both the first direction D1 and the second direction D2 with respect to the fifth attachment state and attached to the support member 40.

The mirror-face adjustment device 30 may also be attached to the support member 40 by using the attachment holes 43 of the fourth zone Z4.

Attachment Seat 44

As illustrated in FIG. 2, the attachment seats 44 are each formed so as to project out from an outer edge of the main body 42 toward a radial direction outside. The attachment seats 44 include a first attachment seat 44A formed in a vicinity of the second zone Z2, a second attachment seat 44B formed in a vicinity of the third zone Z3, and a third attachment seat 44C formed in a vicinity of the fourth zone Z4. Through holes 45 are formed in each of the attachment seats 44 so as to pierce through the attachment seat 44 in a thickness direction thereof. The screws 2 are inserted into the through holes 45, so that the attachment seats 44 is attached to three bosses 16A of a frame shaped visor rim 16 configuring an edge of design surface disposed inside the opening of the visor 14.

The through holes 45 are configured by a first through hole 45A, a second through hole 45B, a third through hole 45C, a fourth through hole 45D, and a fifth through hole 45E.

The first through hole 45A, the second through hole 45B, the third through hole 45C, and the fourth through hole 45D are formed at apexes of a square. The fifth through hole is formed at a center of the square. The through holes 45 are formed with the same diameter as the attachment holes 43, however they may have a different diameter to the attachment holes 43.

Arm 46 As illustrated in FIG. 2, the arm 46 is formed in a plate shape extending in a vehicle width direction. The arm 46 is provided so as to connect the main body 42 and the cover 48 together. A through hole 46A is formed in the arm 46 so as to pierce through the arm 46 in the thickness direction thereof.

Cover 48

The cover 48 configures a cover of the stowing device 50. The cover 48 is attached to the stowing device 50 by screws 2. In other words, the support member 40 is formed integrated to the stowing device 50.

Stowing Device 50

The stowing device 50 is provided with a stand 54 and a rotary body 52. The stand 54 is fixed to an upper end portion of the support section 12. The rotary body 52 is supported by the stand 54, and is configured so as to be able to rotate about a support axis electrically. The visor 14 is able to move between a stowed position and a deployed position. Note that the stowing device 50 may be configured so as to be able to rotate mechanically.

Mirror-Face Adjustment Device Attachment Position Change

Small Mirror

As illustrated in FIG. 2, in a small mirror 20 having a height H1 and a lateral width W1, the mirror-face adjustment device 30 is attached to the support member 40 by the first boss 32A, the second boss 32B, and the third boss 32C being attached by the screws 2 at the first attachment holes 43A of the first zone Z1, the second zone Z2, and the third zone Z3.

In the small mirror 20, the visor rim 16 is attached to the support member 40 by the bosses 16A being attached by the screws 2 to the fourth through hole 45D of the first attachment seat 44A, to the first through hole 45A of the second attachment seat 44B, and to the second through hole 45B of the third attachment seat 44C.

Large Mirror

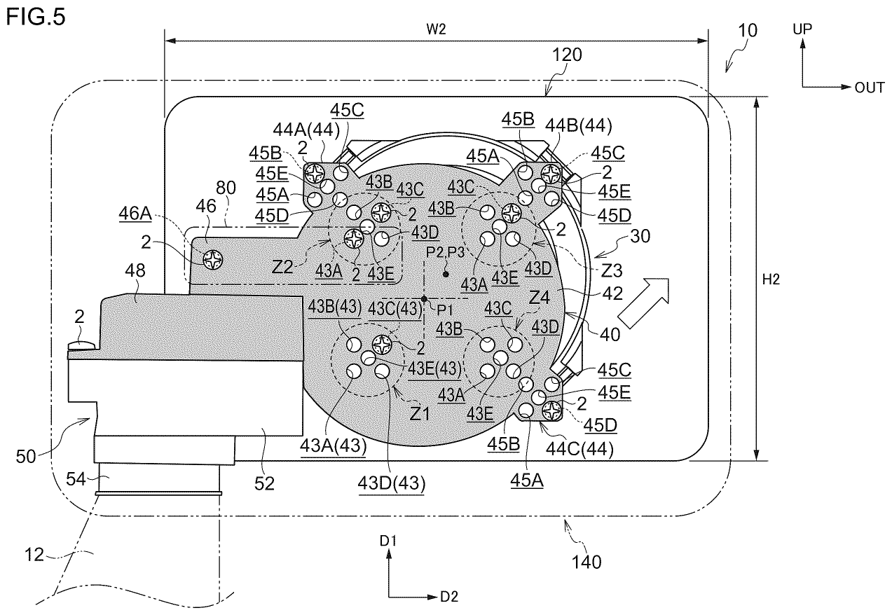

As illustrated in FIG. 5, for a large mirror 120 having a lateral width W2 wider than the lateral width W1 and having a height H2 higher than the height H1, the mirror-face adjustment device 30 is attached to the support member 40 by the first boss 32A, the second boss 32B, and the third boss 32C being attached by the screws 2 at the third attachment holes 43C of the first zone Z1, the second zone Z2, and the third zone Z3.

Moreover, in the large mirror 120, the visor rim 16 is attached to the support member 40 by the bosses 16A being attached by screws 2 to the second through hole 45B of the first attachment seat 44A, the third through hole 45C of the second attachment seat 44B, and the fourth through hole 45D of the third attachment seat 44C.

When this is performed, a screw 2 may be inserted into the first attachment hole 43A of the second zone Z2 and the through hole 46A of the arm 46 such that a reinforcement member 80 is attached to the support member 40.

The mirror 120 may be attached to the mirror-face adjustment device 30 such that the center position P2 of the mirror 120 is slightly displaced from the center position P3 of the mirror-face adjustment device 30.

Moreover, a protrusion may be provided to the base 24A of the mirror holder 24 so as to project toward the vehicle rear side, such that the attachment angle of the large mirror 120 is changed with respect to the mirror holder 24.

Vehicle Viewing Device Operation

In the vehicle viewing device 10, the visor 14 is rotated by operation of the stowing device 50. The visor 14 is accordingly stowed by the visor 14 being rotated toward the vehicle rear side and vehicle width direction inside. Furthermore, the visor 14 is deployed by the visor 14 being rotated toward the vehicle front side and vehicle width direction outside.

The motor 31 is driven under electrical operation of the mirror-face adjustment device 30 so as to move the rod drives 38 in the vehicle front-rear direction. The mirror 20 is thereby tilted by the rod drives 38 in at least one direction of the vehicle up-down direction or the vehicle width direction. An angle of a mirror-face 22A of the mirror 20 (occupant visual check direction assisted by mirror 20) is thereby adjusted in at least one direction of the vehicle up-down direction or the vehicle width direction.

### First Exemplary Embodiment Operation and Advantageous Effects

The vehicle viewing device 10 of the first exemplary embodiment includes the mirror 20 that is configured to assist viewing by an occupant, the mirror-face adjustment device 30 that is configured to adjust the mirror-face 20A of the mirror 20, and the support member 40 that is formed with attachment holes 43, wherein the attachment holes 43 enable attachment of the mirror-face adjustment device 30, with translation, to the support member 40 (see FIG. 2).

By the way, the nearer the pivot point for the mirror 20, which is the center position P3 of the mirror-face adjustment device 30, is to the center position P2 of the mirror 20, the wider the adjustment range of the mirror-face 20A of the mirror 20. There is accordingly a need to change a position of the mirror-face adjustment device 30 with respect to the mirror 20 to match the shape of the mirror 20. This has traditionally resulted in a need to install a new support member to match different shapes of the mirror 20.

The attachment position of the mirror-face adjustment device 30 with respect to the support member 40 is changed and the mirror-face adjustment device 30 is attached to the support member 40 due to provision of the support member 40 that is formed with attachment holes 43, wherein the attachment holes 43 enable attachment of the mirror-face adjustment device 30, with translation, to the support member 40. This accordingly enables the position of the mirror-face adjustment device 30 to be changed to match the shape of the mirror 20. As a result thereof, a support member 40 can be made common to different shaped mirrors 20.

In the vehicle viewing device 10 of the first exemplary embodiment, the direction of translation includes at least one of the first direction D1 or the second direction D2 that is different from the first direction D1 (see FIG. 2).

Due to the direction of translation including the at least one of the first direction D1 or the second direction D2 that is different from the first direction D1, the mirror-face adjustment device 30 is translated and attached to the support member 40 in the at least one of the first direction D1 or the second direction D2. The mirror-face adjustment device 30 is therefore disposed at a more targeted position with respect to different shaped mirrors 20.

In the vehicle viewing device 10 of the first exemplary embodiment, the support member 40 is formed integrated to the stowing device 50 that stows the visor 14 housing the mirror-face adjustment device 30 (see FIG. 2).

The number of components can be reduced due to forming the support member 40 integrated to the stowing device 50 that stows the visor 14 housing the mirror-face adjustment device 30.

In the vehicle viewing device 10 of the first exemplary embodiment, a screw 2 for attachment of the reinforcement member 80 to reinforce the support member 40 is inserted into at least one of the attachment holes 43 (see FIG. 5).

The reinforcement member 80 is thereby attached utilizing attachment holes 43 not needed for attachment of the mirror-face adjustment device 30 by inserting the screw 2 for attachment of the reinforcement member 80 to reinforce the support member 40 into at least one of the attachment holes 43. This thereby enables the support member 40 to be reinforced utilizing the attachment hole 43 not needed for attachment of the mirror-face adjustment device 30.

In the vehicle viewing device 10 of the first exemplary embodiment, plural through holes 45 for attachment of the visor rim 16 are provided in the support member 40 (see FIG. 2).

The attachment position of the visor rim 16 can accordingly be changed due to the providing the plural through holes 45 for attachment of the visor rim 16 in the support member 40. Thus when the position of the mirror-face adjustment device 30 has been changed to match the shape of the mirror 20, the attachment position of the visor rim 16 can also be changed in accordance therewith.

In the vehicle viewing device 10 of the first exemplary embodiment, the mirror-face adjustment device 30 is able to be rotated about the center position P1 of the main body 42 of the support member 40 and attached to the support member 40 (see FIG. 4).

A fastening position where the mirror-face adjustment device 30 is fastened to the support member 40 is changed due to the mirror-face adjustment device 30 being rotated about the center position P1 of the main body 42 of the support member 40 and attachable to the support member 40. This means that the mirror-face adjustment device 30 can be attached to the support member 40 while avoiding an inbuilt object (for example a camera or a harness) of the vehicle viewing device 10. As a result thereof there is no need to provide a new support member 40 in order to avoid the inbuilt object of the vehicle viewing device 10.

In the vehicle viewing device 10 of the first exemplary embodiment, the mirror 20 may be attached to the mirror-face adjustment device 30 with the center position P2 of the mirror 20 slightly displaced from the center position P3 of the mirror-face adjustment device 30.

The attachment orientation of the mirror-face adjustment device 30 can be changed by the mirror 20 being attached to the mirror-face adjustment device 30 such that the center position P2 of the mirror 20 is slightly displaced from the center position P3 of the mirror-face adjustment device 30. This enables additional adjustment to be made to the mirror-face 22A in addition to the adjustment of the mirror-face 22A of the mirror 20 using the mirror-face adjustment device 30.

### Second Exemplary Embodiment

A vehicle viewing device of a second exemplary embodiment differs from the vehicle viewing device of the first exemplary embodiment in that the configuration of the attachment holes is different. Note that similar terms and similar reference numerals will be employed to describe the same or equivalent portions to content described for the first exemplary embodiment.

### Second Exemplary Embodiment Configuration

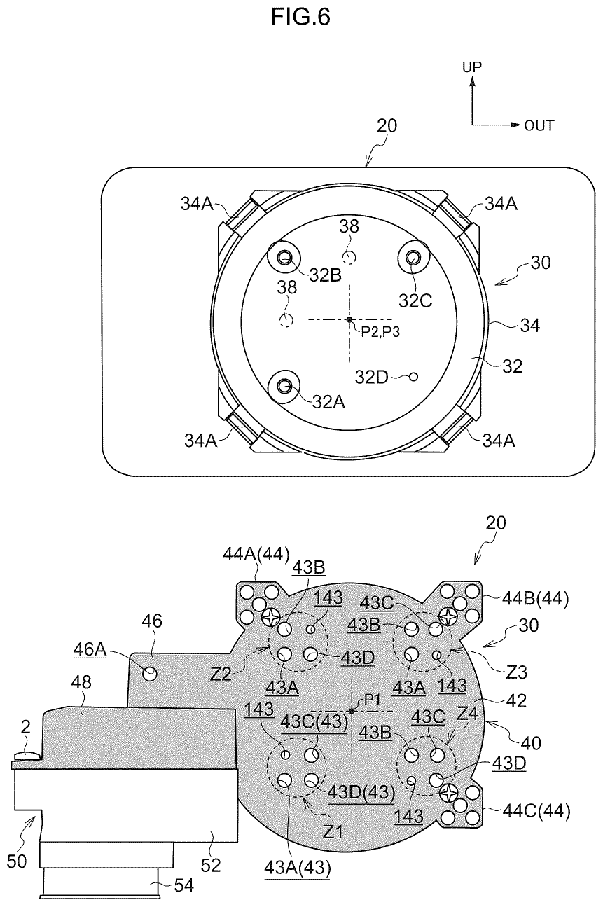

As illustrated in FIG. 6, in the vehicle viewing device 10 of the second exemplary embodiment, attachment holes 43 formed in the respective fastening zones are formed with rotational symmetry about a center position P1 of the main body 42 of the support member 40. The center position P1 configures an attachment center for attachment of the mirror-face adjustment device 30. In addition, attachment holes 43 formed in the respective fastening zones are formed at least at one different position therein, that is, there is at least one fastening zone in which an attachment hole is not formed, at a position corresponding to any one of the attachment holes formed in one of a plurality of fastening zones.

A first attachment hole 43A, a third attachment hole 43C, a fourth attachment hole 43D, and a positioning hole 143 are formed in the first zone Z1 of the main body 42. The first attachment hole 43A, the third attachment hole 43C, the fourth attachment hole 43D, and the positioning hole 143 are formed at apexes of a square. The positioning hole 143 is formed at a vehicle upper side with respect to the first attachment hole 43A. The positioning hole 143 has a smaller internal diameter than the attachment hole 43.

A first attachment hole 43A, a second attachment hole 43B, a fourth attachment hole 43D, and a positioning hole 143 are formed in the second zone Z2 of the main body 42. The first attachment hole 43A, the second attachment hole 43B, the fourth attachment hole 43D, and the positioning hole 143 are formed at apexes of a square. The positioning hole 143 is formed at a vehicle upper side and vehicle width direction outside with respect to the first attachment hole 43A.

A first attachment hole 43A, a second attachment hole 43B, a third attachment hole 43C, and a positioning hole 143 are formed in the third zone Z3 of the main body 42. The first attachment hole 43A, the second attachment hole 43B, the third attachment hole 43C, and the positioning hole 143 are formed at apexes of a square. The positioning hole 143 is formed at a vehicle width direction outside with respect to the first attachment hole 43A.

A second attachment hole 43B, a third attachment hole 43C, a fourth attachment hole 43D, and a positioning hole 143 are formed in the fourth zone Z4 of the main body 42. The second attachment hole 43B, the third attachment hole 43C, the fourth attachment hole 43D, and the positioning hole 143 are formed at apexes of a square. The positioning hole 143 is formed at a vehicle lower side with respect to the second attachment hole 43B.

A positioning pin 32D formed to a back-face of a case 32 of the mirror-face adjustment device 30 is insertable into the positioning hole 143 formed in the respective fastening zones. A first boss 32A, a second boss 32B, a third boss 32C, and the positioning pin 32D are disposed so as to form a square when viewed from the vehicle rear side toward the vehicle front side.

Mirror-Face Adjustment Device Attachment Position Change

### Small Mirror

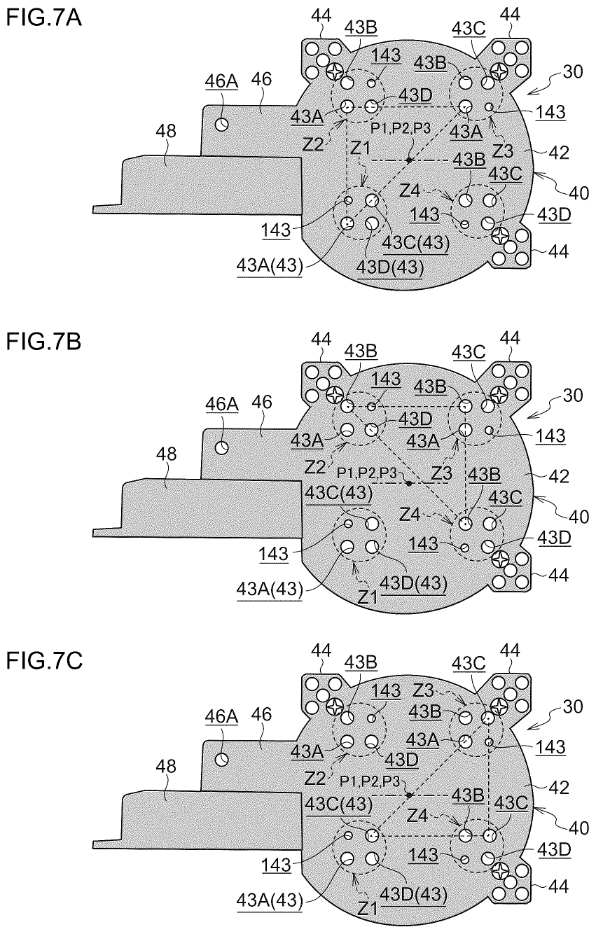

For the case of a small mirror, as illustrated in FIG. 7A, the mirror-face adjustment device 30 is attached to the support member 40 by attaching the first boss 32A, the second boss 32B, and the third boss 32C at the first attachment holes 43A of the first zone Z1, the second zone Z2, and the third zone Z3 using the screws 2. When doing so, the positioning pin 32D is inserted into the positioning hole 143 of the fourth zone Z4 such that the mirror-face adjustment device 30 is positioned with respect to the support member 40.

Medium Sized Mirror

For the case of a medium sized mirror, as illustrated in FIG. 7B, the mirror-face adjustment device 30 is attached to the support member 40 by attaching the first boss 32A, the second boss 32B, and the third boss 32C at the second attachment holes 43B of the second zone Z2, the third zone Z3, and the fourth zone Z4 using the screws 2. When doing so, the positioning pin 32D is inserted into the positioning hole 143 of the first zone Z1 such that the mirror-face adjustment device 30 is positioned with respect to the support member 40.

Large Mirror

For the case of a large mirror, as illustrated in FIG. 7C, the mirror-face adjustment device 30 is attached to the support member 40 by attaching the first boss 32A, the second boss 32B, and the third boss 32C to the third attachment holes 43C of the first zone Z1, the third zone Z3, and the fourth zone Z4 using the screws 2. When doing so, the positioning pin 32D is inserted into the positioning hole 143 of the second zone Z2 such that the mirror-face adjustment device 30 is positioned with respect to the support member 40.

Although not illustrated, the mirror-face adjustment device 30 may also be attached to the support member 40 by attaching the first boss 32A, the second boss 32B, and the third boss 32C to the fourth attachment holes 43D of the first zone Z1, the second zone Z2, and the fourth zone Z4 using the screws 2. When doing so, the positioning pin 32D is inserted into the positioning hole 143 of the third zone Z3 such that the mirror-face adjustment device 30 is positioned with respect to the support member 40.

### Second Exemplary Embodiment Operation and Advantageous Effects

In the vehicle viewing device 10 of the second exemplary embodiment, the support member 40 includes the plural fastening zones configured to fasten the mirror-face adjustment device 30 to the support member 40, and the attachment holes 43 formed in the respective fastening zones are formed with rotational symmetry about a center position P1 of the support member 40 and are formed at least at one different position therein (that is, there is at least one fastening zone in which an attachment hole is not formed, at a position corresponding to any one of the attachment holes formed in one of the plurality of fastening zones.) (see FIG. 6).

The attachment holes 43 formed in the respective fastening zones are formed with rotational symmetry about the center position P1 of the support member 40, and so the mirror-face adjustment device 30 may be attached, with rotational movement and translation, to the support member. Moreover, due to the attachment holes 43 formed in the respective fastening zones being formed at least at one different position, incorrect assembly can be suppressed from occurring. This accordingly enables the mirror-face adjustment device 30 to be disposed at a target position matched to different shaped mirrors 20 while also suppressing incorrect assembly.

In the vehicle viewing device 10 of the second exemplary embodiment, the positioning pin 32D formed to the mirror-face adjustment device 30 is inserted into at least one attachment hole 43 (see FIG. 6).

Due to inserting the positioning pin 32D formed to the mirror-face adjustment device 30 into at least one of the attachment holes 43, an attachment hole 43 not needed for attachment of the mirror-face adjustment device 30 is employed, enabling positioning of the mirror-face adjustment device 30 to be performed with respect to the support member 40.

Note that other configuration and operation and advantageous effects are substantially the same as those of the first exemplary embodiment and so explanation thereof will be omitted.

### Third Exemplary Embodiment

A vehicle viewing device of a third exemplary embodiment differs from the vehicle viewing device of the first exemplary embodiment in that the configuration of the attachment holes is different. Note that similar terms and similar reference numerals will be employed to describe the same or equivalent portions to content described for the first exemplary embodiment.

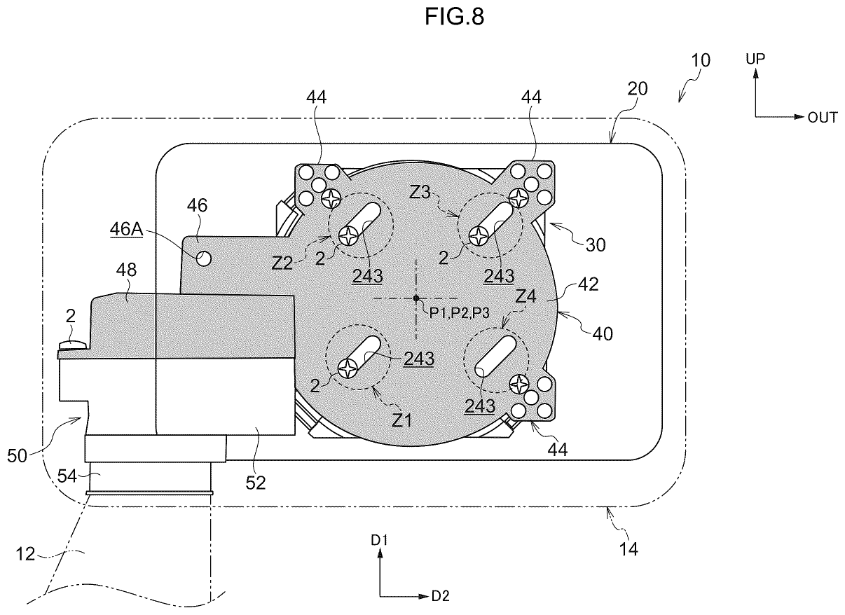

As illustrated in FIG. 8, in a vehicle viewing device 10 of the third exemplary embodiment, attachment holes 243 formed in respective fastening zones are formed as elongated holes extending in both the first direction D1 and the second direction D2. A configuration such as this also exhibits similar advantageous effects to those of the first exemplary embodiment.

### Fourth Exemplary Embodiment

A vehicle viewing device of a fourth exemplary embodiment differs from the vehicle viewing device of the first exemplary embodiment in that the configuration of the attachment holes is different. Note that similar terms and similar reference numerals will be employed to describe the same or equivalent portions to content described for the first exemplary embodiment.

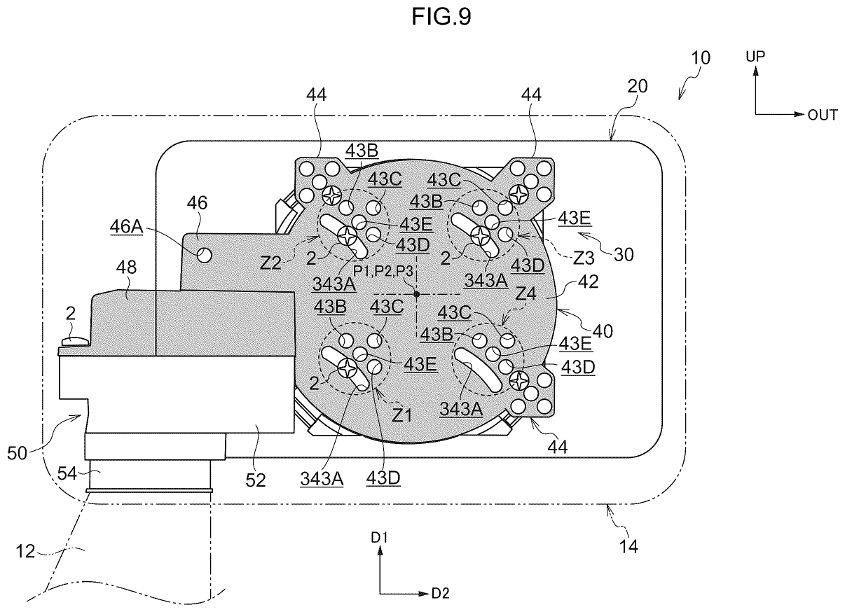

As illustrated in FIG. 9, in the vehicle viewing device 10 of the fourth exemplary embodiment, first attachment holes 343A formed in the respective fastening zones are formed as circular arc shaped elongated holes projecting in a direction diagonally toward the vehicle outside and upward. The mirror-face adjustment device 30 is able to be rotatably moved and attached to the support member 40 by employing the first attachment holes 343A of the first zone Z1, the second zone Z2, and the third zone Z3. Due to provision of the first attachment holes 343A enabling rotational movement of the mirror-face adjustment device 30, the mirror-face adjustment device 30 can be attached to the support member 40 while the mirror face adjustment device 30 is both translated with respect to the support member 40 and furthermore rotationally moved. The accordingly enables the mirror-face adjustment device 30 to be disposed at a more targeted position with respect to different shaped mirrors 20. Translation encompasses situations in which the mirror-face adjustment device 30 is rotated and moved about a point not at an attachment hole, as described above.

Note that other configuration and operation and advantageous effects are substantially the same as those of the first exemplary embodiment and so explanation thereof will be omitted.

### Fifth Exemplary Embodiment

A vehicle viewing device of a fifth exemplary embodiment differs from the vehicle viewing device of the first exemplary embodiment in that the configuration of the attachment holes is different. Note that similar terms and similar reference numerals will be employed to describe the same or equivalent portions to content described for the first exemplary embodiment.

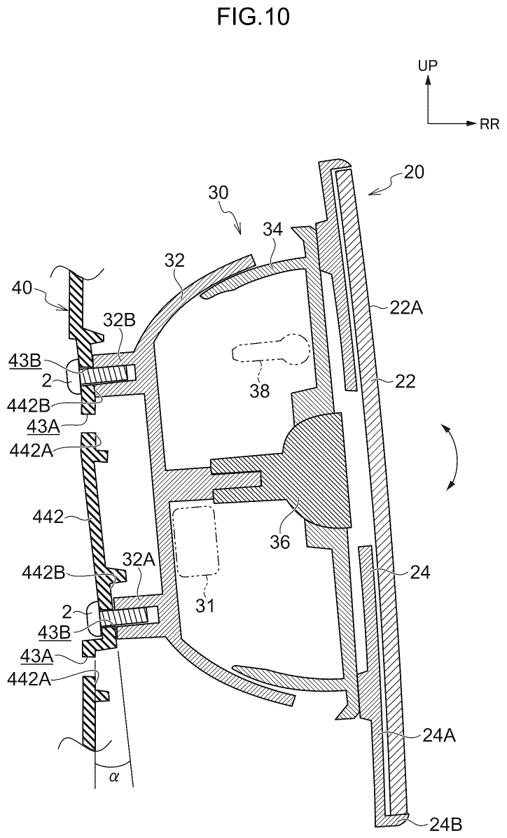

As illustrated in FIG. 10, in the vehicle viewing device 10 of the fifth exemplary embodiment, an angle α is formed between a first face 442A of a main body 442 formed with first attachment holes 43A of respective fastening zones, and a second face 442B of the main body 442 formed with second attachment holes 43B of the respective fastening zones. The first face 442A is formed parallel to a vertical plane including the vehicle up-down direction. The second face 442B is formed inclined at the angle α toward the vehicle upper side with respect to the first face 442A.

Note that a face formed with a third attachment hole 43C may be formed inclined with respect to the first face 442A, and a face formed with a fourth attachment hole 43D may be formed inclined with respect to the first face 442A.

The attachment holes 43 include the first attachment holes 43A provided to the first face 442A and the second attachment holes 43B provided to the second face 442B that is inclined with respect to the first face 442A, and so the orientation of the mirror-face adjustment device 30 changes between when the mirror-face adjustment device 30 is attached at the first attachment holes 43A and when attached at the second attachment holes 43B. This thereby enables the mirror-face adjustment device 30 to be translated with respect to support member 40 and furthermore enables the orientation of the mirror-face adjustment device 30 to be changed. Moreover, this enables additional adjustment to be made to the angle of the mirror-face 20A in addition to the adjustment of the angle of the mirror-face 20A of the mirror 20 using the mirror-face adjustment device 30.

Note that other configuration and operation and advantageous effects are substantially the same as those of the first exemplary embodiment and so explanation thereof will be omitted.

The vehicle viewing device of the present disclosure has been described based on the first exemplary embodiment to the fifth exemplary embodiment. However, specific configurations are not limited to those of these exemplary embodiments, and various design changes and the like may be implemented without straying from the spirit of the invention as recited by each claim of the following scope of patent claims.

The first exemplary embodiment to the fifth exemplary embodiment illustrated examples in which the support member 40 is attached to the mirror-face adjustment device 30 by the screws 2 serving as attachment members. However, a support member may be attached to a mirror-face adjustment device by resin claws serving as attachment members.

The first exemplary embodiment to the fifth exemplary embodiment illustrated examples in which the mirror-face adjustment device 30 adjusts an angle of the mirror-face 22A of the mirror 20 electrically. However, the mirror-face adjustment device 30 may adjust the angle of the mirror-face 22A of the mirror 20 mechanically.

The first exemplary embodiment to the fifth exemplary embodiment illustrated examples in which the support member 40 included four fastening zones. However, a support member may include three fastening zones, or may include five or more fastening zones.

The first exemplary embodiment to the fifth exemplary embodiment illustrated examples in which the support member 40 included the attachment seat 44 for attachment of the visor rim 16. However, the support member may be configured without an attachment seat.

The first exemplary embodiment to the fifth exemplary embodiment illustrated examples in which the support member 40 was configured as a cover of the stowing device 50. However, a support member may be configured as a case of a stowing device, and may be configured as a separate body to the stowing device.

The first exemplary embodiment, the fourth exemplary embodiment, and the fifth exemplary embodiment illustrated examples in which five attachment holes formed in each of the fastening zones are provided, the second exemplary embodiment illustrated an example in which three attachment holes formed in each of the fastening zones are provided, and the third exemplary embodiment illustrated an example in which a single attachment hole formed in each of the fastening zones is provided. However, the number of attachment holes formed in each of the fastening zones is not limited to the numbers in these embodiments.

The first exemplary embodiment to the fifth exemplary embodiment illustrated examples in which the mirror 20 had a rectangular plate shape. However, the shape of the mirror is not limited to that of these embodiments, and may be a circular, an elliptical, or a polygonal plate shape.

The fifth exemplary embodiment illustrated an example in which the second face 442B is formed inclined with respect to the first face 442A toward the vehicle upper side. However, a second face may be formed inclined with respect to a first face toward a vehicle side, or may be formed inclined with respect thereto toward the vehicle upper side and toward a vehicle side.

The first exemplary embodiment to the fifth exemplary embodiment illustrated examples in which the vehicle viewing device 10 is a door mirror attached to a front side door of a vehicle. However, the vehicle viewing device may be another mirror attached to a vehicle.

What is claimed is:

1. A vehicle viewing device comprising:
a mirror that is configured to assist viewing by an occupant;
a mirror-face adjustment device that is configured to adjust a mirror-face of the mirror; and
a support member that is formed with attachment holes, wherein the attachment holes enable attachment of the mirror-face adjustment device, with translation, to the support member.

2. The vehicle viewing device of claim 1, wherein a direction of translation includes at least one of a first direction or a second direction that is different from the first direction.

3. The vehicle viewing device of claim 1, wherein the attachment holes are provided so as to enable attachment of the mirror-face adjustment device, with rotational movement, to the support member.

4. The vehicle viewing device of claim 1, wherein:
the attachment holes include a first attachment hole provided at a first face, and a second attachment hole provided at a second face that is inclined with respect to the first face.

5. The vehicle viewing device of claim 1, wherein the support member is integrally formed to a stowing device that stows a visor housing the mirror-face adjustment device.

6. The vehicle viewing device of claim 1, wherein:
the support member includes a plurality of fastening zones configured to fasten the mirror-face adjustment device to the support member; and
the attachment holes formed in the respective fastening zones are formed with rotational symmetry with respect to an attachment center of the support member, and
there is at least one fastening zone in which an attachment hole is not formed, at a position corresponding to any one of the attachment holes formed in one of the plurality of fastening zones.

7. The vehicle viewing device of claim 1, wherein a positioning pin formed at the mirror-face adjustment device is inserted into at least one of the attachment holes.

8. The vehicle viewing device of claim 1, wherein an attachment member, configured to attach a reinforcement member to reinforce the support member, is inserted into at least one of the attachment holes.

9. The vehicle viewing device of claim 1, wherein a plurality of through holes configured to attach a visor are provided at the support member.
